(19) United States
(12) Patent Application Publication
(10) Pub. No.: US 2004/0134923 A1
(43) Pub. Date: Jul. 15, 2004

(54) Odor-neutralizing and liquid-absorbing trash bags

(75) Inventors: Melissa Dee Aquino, Cincinnati, OH (US); I-Chun Jennifer Chiao, Mason, OH (US); Chandrika Kasturi, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/717,099

(22) Filed: Nov. 19, 2003

Related U.S. Application Data
(63) Continuation of application No. 09/831,782, filed on May 14, 2001.
(63) Continuation of application No. PCT/US99/26969, filed on Nov. 16, 1999.
(60) Provisional application No. 60/108,665, filed on Nov. 16, 1998.

(51) Int. Cl. A47J 31/00

(52) U.S. Cl. 220/912; 99/467

(57) ABSTRACT

A bag or other flexible container for the disposal of food wastes and scraps contains inside an absorbent material on which is deposited an odor-neutralizing composition. Solid and liquid food wastes are placed inside the bag, which is then sealed and placed in a home trash receptacle.

### CROSS-REFERENCE TO RELATED APPLICATIONS

This application is a continuation of PCT/US99/26969, filed under 35 U.S.C. 371 on Nov. 16, 1999, which claims the benefit of 60/108,665, filed Nov. 16, 1998.

### FIELD OF THE INVENTION

The present invention relates to containers for use in disposing of food wastes and scraps. The container is constructed from liquid impervious walls and includes an absorbent material to contain liquid food wastes and an odor-neutralizing composition deposited on the absorbent material.

### BACKGROUND OF THE INVENTION

During the preparation and consumption of a meal or food products, it is typical to generate inedible or unwanted food scraps and wastes. Such scraps and wastes may include vegetable or fruit peels, liquid grease and fats, meat juices and other meat by-products and animal bones. The safe and hygienic disposal of these scraps can add a substantial amount of extra effort at the conclusion of food preparation.

Generally, these food scraps are disposed of by placing or pouring them into a paper or plastic trash bag. The bag is stored in or in proximity to a consumer's home until such time as it is collected by a local waste disposal agency. While this method is of disposing of food wastes is convenient, it presents several problems. First, liquid food wastes often leak through the bag, thus spreading the food wastes over a larger area. Second, unless the bags are stored at a temperature substantially below room temperature then the decomposition of the food wastes will produce strong and unpleasant malodors. Third, the decomposition of the food wastes emit chemical and other scents which attract animals and insects.

The most effective current approach to dealing with food wastes and scraps is to place them in an in-sink garbage disposal unit where they are ground into small particles and then carried away in the wash water. But many consumers do not have garbage disposals, which can be expensive and difficult to retrofit into the plumbing of older homes.

Given the foregoing, there is a continuing need for an economical and disposable bag into which food wastes and scraps can be easily and conveniently placed and contained. Such a bag would contain and absorb liquid food wastes as well as molecules responsible for malodors. The result would be the elimination of odors and scents emanating from the food wastes which are not only unpleasant but also attract animals and insects.

Many consumers currently use such plastic bags which are inexpensive and disposable. A consumer will place the food scraps and wastes inside a thin plastic bag (often obtained from a food retailer), tie the bag closed and then place the bag in a garbage can. But this is only a temporary solution. Malodors may soon diffuse out of the thin plastic of which such bags are constructed and such bags will typically provide only brief containment of liquid wastes. Additionally, because these bags were generally not designed to contain a liquid, they lack an adequate closure and sealing means, thus providing another potential leakage route for liquid wastes.

Accordingly, a benefit of the present invention is that it provides an economical, leak-proof plastic bag that is suitable for the disposal of food scraps and wastes and includes an odor-neutralizing ingredient which neutralizes undesirables odors as well as an absorbent material which absorbs liquid wastes. This bag is suitable for the disposal of food wastes and scraps with superior leak protection and odor-suppression is provided as a result.

### SUMMARY OF THE INVENTION

The present invention encompasses a container for use in the disposal of food scraps and wastes. The container is composed of liquid impervious walls which have inner and outer surfaces and placed inside the container is an absorbent material. The absorbent material has an effective amount of an odor-neutralizing composition deposited upon it. Preferably the absorbent material is attached to the inner surfaces of the container walls. This container preferably also comprises a means for closing and sealing itself. In a preferred mode, the walls of the container are constructed from a thin, flexible plastic. Depending on the desires of the formulator, the container herein can have the absorbent material joined on the inner surface of the walls in a continuous layer, or intermittently.

It is preferable that the odor-neutralizing composition deposited on the absorbent material include: an odor-absorbing ingredient selected from the group comprising cyclodextrin, activated charcoal, baking soda, zeolite, silica and mixtures thereof, a chelant, and an antimicrobial agent.

In an alternate embodiment the container additionally comprises a liquid pervious liner which is positioned adjacent to an absorbent material which has an effective amount of an odor-neutralizing compound deposited on it. The absorbent material is positioned adjacent to the inner surface of the liquid impervious walls. The liquid impervious walls have inner and outer surfaces and define an opening for receiving the food wastes.

In another embodiment, instead of using an odor-absorbing ingredient, a perfume is releasably deposited on the absorbent material. The invention also encompasses a process for the disposal of food wastes, which includes placing the food wastes within a container as described above whereby the food wastes come in contact with the odor-neutralizing compositions deposited on the absorbent material; and then placing the container in one of the home's trash receptacle.

All percentages, ratios and proportions herein are by weight, unless otherwise specified. All documents cited are, in relevant part, incorporated herein by reference.

### BRIEF DESCRIPTION OF THE DRAWINGS

FIG. 1 is a perspective of a flexible plastic bag according to the present invention in a pre-folded configuration.

FIG. 2 is a perspective of the bag shown in FIG. 1 in folded configuration.

FIG. 3 is a perspective similar to FIG. 1 of an alternate embodiment showing the absorbent material joined to the inner walls of the container surfaces in a striped pattern according to the present invention.

FIG. 4 is a perspective of the bag shown in FIG. 3 in folded configuration.

### DETAILED DESCRIPTION OF THE INVENTION

By “effective amount” herein is meant any amount capable of neutralizing the odors emitted by food scraps and wastes placed inside the presently disclosed container or any amount capable of masking such odors. In general, this amount may vary quite widely.

By “joined” herein is meant any configuration whereby an element is directly secured to the other element by affixing the element directly to the other element, and configurations whereby the element is indirectly secured to the other element by affixing the element to intermediate member(s) which in turn are affixed to the other element.

The components of the present invention and their use in the process of the present invention are describe hereinafter.

Container—The present food waste disposal process is conducted using a flexible container. The food wastes to be disposed of are placed within the container, the container is sealed and then placed in a trash or garbage receptacle.

The container used herein can be provided in any number of configurations, and is conveniently in the form of a flexible pouch, or “bag”, which has sufficient volume to contain the fabrics being cleaned. Suitable containers can be manufactured from any flexible and economical material, impervious to liquids (e.g., liquid food wastes) and is preferably manufactured from a thin plastic film, although other flexible liquid impervious materials may also be used. The walls of the container prevent liquid food wastes absorbed and contained in the absorbent material from leaking out of the container. These walls may comprise a woven or nonwoven material, polymeric films such as thermoplastic films of polyethylene or polypropylene, or composite materials such as a film-coated nonwoven material.

It is preferred that the container be provided with a sealing means which is sufficiently stable to remain closed during the cleaning process. Simple tie strings or wires, various snap closures such as ZIP LOK® closures, and VELCRO®-type closures, contact adhesive, adhesive tape, zipper-type closures, and the like, suffice. The container can be of any convenient size, and should be sufficiently large to allow the disposal of food scraps and wastes generated in the process of preparing an average-sized meal.

Attached directly to the inner surface of the liquid impervious container walls (1) is an absorbent material (2) designed to absorb and contain liquid food wastes that may be deposited inside the container. Suitable types of absorbent material and means for attaching the absorbent material to the container are discussed in greater detail below.

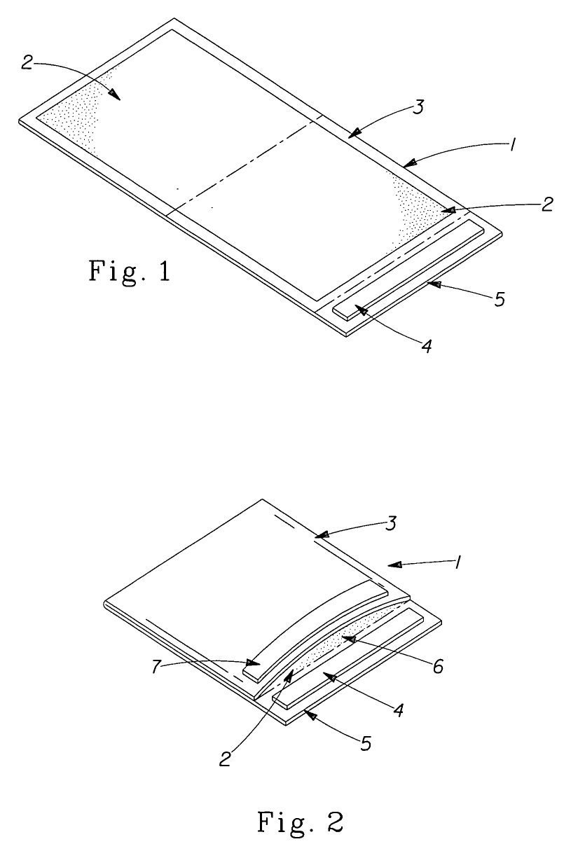

In one embodiment of the invention, an absorbent material (2) is joined to a flat sheet (1) of flexible plastic as shown in FIG. 1. The odor-neutralizing composition is deposited on the surface of the absorbent material (2). The border (3) of the sheet along its lateral edges is free of the absorbent material. Strip (4) comprises a layer of contact adhesive as a sealing means on closure flap (5). As shown in FIG. 2, a bag is formed by folding the sheet of FIG. 1 and bonding along the border (3). The absorbent material (2) is on the inner walls of the bag, and are visible in the opening (6) of the bag as shown in the FIG. 2. Closure flap (5) with sealing means (4) allow closing and sealing of the bag by imposing sealing means (4) onto contact surface (7). In this embodiment, the absorbent material is a substantially continuous layer on all or any selected part of the container article's inner surfaces.

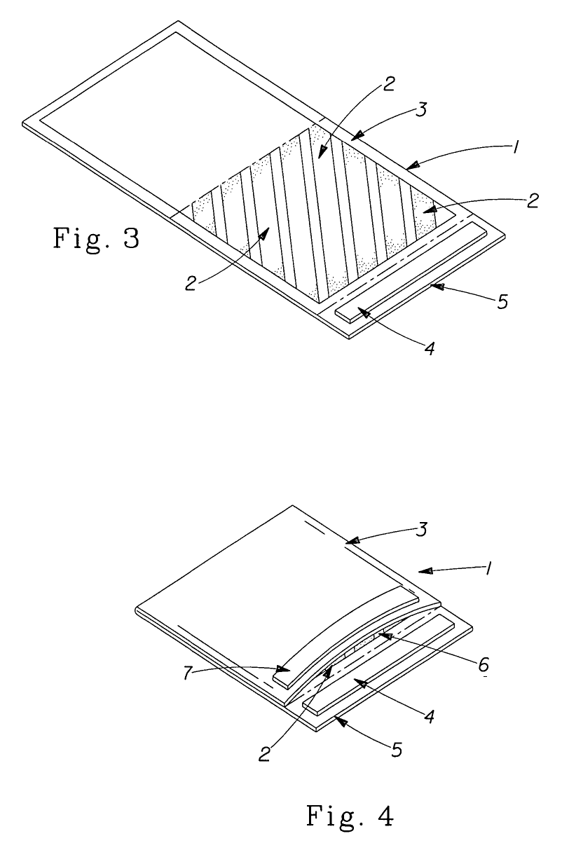

In an alternate embodiment of the invention, the absorbent material (2) is attached to all or any selected parts of the sheet (1) in an intermittent pattern, e.g., as stripes, dots, figures, or the like. As depicted in FIG. 3, this alternate embodiment can be prepared using a flat sheet (3) having a striped pattern of the absorbent material (2) applied to part of its surface. As shown in FIG. 4, the sheet is folded to form a bag of the present type having stripes of the cleaning composition (2) on one of its inner walls. Because less of the absorbent material (2) is used, attaching the absorbent material (2) in an intermittent pattern offers the advantage of being less costly. Nonetheless, the practitioner must be careful to use an amount of material sufficient to absorb and contain the liquid food wastes placed inside the container.

In an alternate embodiment the container additionally comprises a liquid pervious liner which is positioned adjacent to an absorbent material which has an effective amount of an odor-neutralizing compound deposited on it. The absorbent material is positioned adjacent to the inner surface of the liquid impervious walls. The liquid impervious walls have inner and outer surfaces and define an opening for receiving the food wastes. In this embodiment it is preferred that the inner surface of the liquid impervious walls and the liquid pervious liner are joined directly to each other and are indirectly joined together by directly joining them to the absorbent material by attachment means (not shown). Suitable attachment means are described below.

The liquid pervious liner is compliant, soft feeling, and non-irritating to human skin and allows liquids to readily penetrate through its thickness. By providing the liner, a consumer who places his or her hand into the container in the process of placing food wastes and scraps inside will not have incidental and undesirable contact with the absorbent material which is nearly or completely saturated with liquid wastes.

A suitable liquid pervious liner may be manufactured from a wide range of materials, such as porous foams; reticulated foams; apertured plastic films; or woven or nonwoven webs of natural fibers (e.g., wood or cotton fibers), synthetic fibers (e.g., polyester or polypropylene fibers), or a combination of natural and synthetic fibers.

The Absorbent Material—The present invention contains an absorbent material which absorbs and contains liquid food wastes produced during the preparation and consumption of a meal or other food products. By so absorbing liquids, the chance of leakage of these liquids out of the container is significantly decreased.

The absorbent material may be any absorbent means which is generally compressible and non-irritating to human skin, and capable of absorbing and retaining liquid food wastes. The absorbent material may be manufactured from a wide variety of liquid-absorbent materials commonly used in absorbent articles such as comminuted wood pulp which is generally referred to as airfelt. Examples of other suitable absorbent materials include creped cellulose wadding, meltblown polymers including coform, cross-linked cellulosic fibers, tissue including tissue wraps, absorbent foams, absorbent sponges, superabsorbent polymers, absorbent gelling materials, or any equivalent material or combinations of materials. The total absorbent capacity of the absorbent core should, however, be compatible with the design loading and the intended use of the container.

As described above, the absorbent material is placed inside the container. It is preferable for the absorbent material (2) to be either attached to the inner surface of the liquid impervious container walls (1) as shown in FIG. 1; or in an alternate embodiment positioned between the inner surface of the liquid impervious container walls (1) and a liquid pervious liner. In this embodiment, the liquid impervious layer may be secured to the absorbent material by a uniform continuous layer of adhesive, a patterned layer of adhesive, or an array of separate lines, spirals, or spots of adhesive. An exemplary attachment means of an open pattern network of filaments comprises several lines of adhesive filaments swirled into a spiral pattern such as is illustrated by the apparatus and methods shown in U.S. Pat. No. 3,911,173 issued to Sprague, Jr. on Oct. 7, 1975; U.S. Pat. No. 4,785,996 issued to Ziecker, et al. on Nov. 22, 1978; and U.S. Pat. No. 4,842,666 issued to Werenicz on Jun. 27, 1989, incorporated herein by reference. Alternatively, the attachment means may comprise heat bonds, pressure bonds, ultrasonic bonds, dynamic mechanical bonds, or any other suitable attachment means or combinations of these attachment means as are known in the art.

Odor-neutralizing Compositions—The chemical compositions which are used to provide the odor-neutralizing function in the present food waste disposal process comprise ingredients which are safe and effective for their intended use. These compositions include “direct” odor-neutralizers and may optionally contain “indirect” odor-neutralizers as well. Direct odor-neutralizers are molecules possessing a certain structural configuration that enables them to absorb and thus eliminate a broad array of odoriferous molecules. Indirect odor-neutralizers are those components which interrupt the biological processes responsible for malodors, particularly the processes involving the decomposition of food wastes by bacterial and microbial activity. Indirect neutralizers have the disadvantage of being effective only in preventing the growth of malodor-producing microorganisms and are not capable of reducing malodors that have already been produced.

Some examples of direct odor-neutralizers are activated charcoal, baking soda, absorbent gelling materials, zeolite and silica. Another suitable odor-neutralizer is cyclodextrin, which is more completely described in U.S. Pat. No. 5,593,670, to Trinh et al., issued Jan. 14, 1997, hereby incorporated by reference. The absorbent materials may comprise from about 20 g/m² to about 400 g/m² of a direct odor-neutralizer.

Indirect odor-neutralizers include antimicrobial agents which regulate the malodor-producing microorganisms found in the liquid food wastes which have been absorbed and contained in the absorbent material. Chelants are another type of an indirect odor-neutralizer which act by deactivating the enzymes used by bacteria to decompose the organic molecules found in liquid food wastes. The formulator may elect to include either an antimicrobial agent or a chelant or both. The absorbent materials may comprise from about 10 g/m² to about 500 g/m² of an antimicrobial agent and from about 5 g/m² to about 300 g/m² of a chelant.

When cyclodextrin is used as a direct odor-neutralizer, it is preferable to use indirect odor-neutralizers as well, because certain microorganisms grow extremely well on cyclodextrin. Contamination of the absorbent material upon which cyclodextrin is deposited by certain microorganisms and the subsequent growth of those microorganisms can result in the containers of the present invention being malodorous before even the first use.

Thus the antimicrobial agents in the present invention are included for two different purposes: first, to prevent spoilage of the cyclodextrin ingredient by preventing growth of inadvertently added microorganisms in or on the surface of the absorbent material upon which cyclodextrin has been deposited; and second, to kill microorganisms in the liquid wastes which have been absorbed and contained in the absorbent material in order to eliminate the odors produced by the activity of these microorganisms.

In the present chemical compositions it is preferable to use a broad spectrum antimicrobial agent, e.g., one that is effective on both bacteria (both gram positive and gram negative) and fungi. A limited spectrum agent, e.g., one that is only effective on a single group of microorganisms, e.g., fungi, can be used in combination with a broad spectrum agent or other limited spectrum agents with complimentary and/or supplementary activity. A mixture of broad spectrum agents can also be used. Antimicrobial agents useful in the present invention include biocidal compounds, i.e., substances that kill microorganisms, or biostatic compounds, i.e., substances that inhibit and/or regulate the growth of microorganisms.

Because microbial growth in cyclodextrin solutions is highly objectionable when it occurs, it is highly preferable to include a solubilized, water-soluble, antimicrobial agent, which is effective for inhibiting and/or regulating microbial growth in order to increase storage stability of the solution or mixture containing water-soluble cyclodextrin. Preferred anitmicrobial agents for use with cyclodextrin are described in greater detail in U.S. Pat. No. 5,593,670, to Trinh et al.

The antimicrobial agents in the present invention are included at levels which are sufficient to prevent spoilage of the cyclodextrin and to kill microorganisms contained in the absorbent material.

The odor-neutralizing compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Amino carboxylates useful as optional chelating agents include ethylenediaminetetracetates, N-hydroxyethylethylenediaminetriacetates, nitrilotriacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein. Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene. A suitable biodegradable chelator for use herein is ethylenediamine disuccinate (“EDDS”), especially the [S,S] isomer as described in U.S. Pat. No. 4,704,233, Nov. 3, 1987, to Hartman and Perkins.

A formulator may also elect to releasably deposit perfumes on the absorbent material. Rather than absorb odoriferous molecules, the perfumes mask their presence. When the formulator so chooses to use perfumes, direct odor-neutralizers (i.e. odor-absorbers) are not included in the odor-neutralizing composition. The formulator may choose to use either or both of the above-mentioned anitmicrobial agents and chelants in combination with the perfume.

The odor-neutralizing compositions of the present invention are deposited and contained in and on the absorbent material described herein. The compositions can be applied to the absorbent material by any convenient means, including, but not limited to, rinsing, spraying, dipping, and the like. The odor-neutralizing compositions can also be deposited or incorporated into the absorbent material according to the methods disclosed in European Patent Application No. 0,811,390 A1, to Guarracino et al., published Oct. 10, 1997, hereby incorporated by reference. In an alternate mode, the odor-neutralizing composition can be applied using rotogravure or other types of “printing” processes; see U.S. Pat. No. 4,663,198, to Norris, issued May 5, 1980.

Process—The present food waste disposal process can be conducted in any manner provided that the food wastes are safely and hygienically disposed. However, in a convenient mode the food wastes are placed within a container as described above whereby the food wastes come in contact with the odor-neutralizing compositions deposited on the absorbent material. The container is then sealed and placed in one of the consumer's trash receptacles.

What is claimed is:

1. A container for the disposal of food wastes, said container comprising:
liquid impervious walls having inner and outer surfaces, said walls defining an opening of said container, said food wastes being depositable in said container through said opening;
an absorbent material deposited upon said inner surface of said container, said absorbent material having deposited thereupon an effective amount of an odor-neutralizing composition; and,
a liquid pervious liner positioned adjacent said absorbent material.

2. The container of claim 1, wherein said absorbent material is joined to said inner surface.

3. The container of claim 1, further comprising a means for closing and sealing said container.

4. The container of claim 3, wherein said means for closing and sealing said container comprises a layer of contact adhesive.

5. The container of claim 1, wherein said liquid impervious walls are a flexible material.

6. The container of claim 5, wherein said container is a flexible bag.

7. The container of claim 1, wherein said odor-neutralizing composition is selected from the group consisting of cyclodextrin, activated charcoal, baking soda, absorbent gelling materials, zeolites, silica, and combinations thereof.

8. The container of claim 7, wherein said odor-neutralizing composition further comprises a chelant.

9. The container of claim 8, wherein said chelant is deposited upon said absorbent material in an amount ranging from about 5 g/m² to about 300 g/m².

10. The container of claim 8, wherein said chelant is selected from the group consisting of amino carboxylates, amino phosphonates, polyfunctionally-substituted aromatic chelating agents, and mixtures thereof.

11. The container of claim 8, wherein said chelant is biodegradable.

12. The container of claim 1, wherein said odor-neutralizing composition comprises:
an odor-absorbing ingredient selected from the group consisting of cyclodextrin, activated charcoal, baking soda, absorbent gelling materials, zeolites, silica, and combinations thereof;
a chelant; and,
an antimicrobial agent.

13. The container of claim 1, wherein said liquid impervious walls are manufactured from a material selected from the group consisting of woven materials, non-woven materials, polymeric films, composite materials, and combinations thereof.

14. The container of claim 1, further comprising a closure flap articulably connected to at least one of said liquid impervious walls.

15. The container of claim 1, wherein said absorbent material is discontinuously deposited upon said inner surface of said container.

16. The container of claim 1, wherein said absorbent material is continuously deposited upon said inner surface of said container.

17. The container of claim 1, wherein said odor-neutralizing composition further comprises an antimicrobial agent.

18. The container of claim 17, wherein said antimicrobial agent is deposited upon said absorbent material ranging from about 10 g/m² to about 500 g/m².
